(19) United States
(12) Patent Application Publication
(10) Pub. No.: US 2017/0225172 A1
(43) Pub. Date: Aug. 10, 2017

(54) Monitor and Control of Tumbling Mill Using Measurements of Vibration, Electrical Power Input and Mechanical Power

(71) Applicant: Emerson Electric (US) Holding Corporation (Chile) Limitada, Santiago (CL)

(72) Inventors: Daniel L. Nower, Knoxville, TN (US); Stewart V. Bowers, Knoxville, TN (US); Scott T. Bassett, Knoxville, TN (US); Raymond E. Garvey, III, Loudon, TN (US); Randal M. Doss, Lufkin, TX (US); Mark W. Slemp, Knoxville, TN (US); Tuhin Banerjee, Ontario (CA); Michael Schaffer, Ontario (CA)

(73) Assignee: Emerson Electric (US) Holding Corporation (Chile) Limitada, Santiago (CL)

(21) Appl. No.: 15/502,300

(22) PCT Filed: Aug. 5, 2015
(86) PCT No.: PCT/US2015/043780

§ 371 Date: Feb. 7, 2017

Related U.S. Application Data
(60) Provisional application No. 62/034,359, filed on Aug. 7, 2014.

(51) Int. Cl. B02C 17/18; B02C 25/00

(52) U.S. Cl. CPC B02C 17/1805; B02C 25/00

(57) ABSTRACT

An apparatus monitors a tumble mill and includes at least two vibration sensors mounted on a first main bearing and at least two vibration sensors mounted on a second main bearing of the mill. Sensors may be disposed radially with respect to the bearing. A vibration sensor is also connected to a thrust bearing of the mill oriented in a direction parallel to the rotational axis of the shell of the mill. A signal analyzer receives and analyzes signals from all vibration monitors on the bearings and displays an operating condition of the tumble mill. Additional vibration sensors may be mounted on the shell, and sensors may be provided to sense electrical power input and mechanical power output of the motors. In operation, the mill is loaded with a standard charge and operated at a standard rotational rate. The sensor data is analyzed and displayed when the mill is operating.

### PRIORITY

This application claims priority to U.S. Patent Application 62/034,359 filed on Aug. 7, 2014, entitled Monitor and Control Tumbling Mill Using Vibration Inputs incorporated by reference herein in its entirety.

### FIELD

The present invention relates to the field of tumbler mills and particularly relates to the monitoring and control of tumbler mills using vibration, electrical and power measurements

### BACKGROUND AND SUMMARY OF INVENTION

Grinding in tumbling mills may be inefficient particularly where energy is wasted by impact that does not break particles. Autogenous (AG) and semi-autogenous (SAG) mills often operate in an unstable state because of the difficulty in balancing the rate of replacement of large particles from the seed with the consumption of the charge. To control this process it is essential that real-time information be provided as to the current state of the charge in the tumbler. Past processes have used sensors on the shell of the tumbler and sensors off of the shell (such as acoustic sensors) in an effort to monitor the change in condition of the charge within the grinder. Changes in the vibration or the sound of the charge have been used to gain some information concerning the state of the charge within a tumbling or grinding mill. Improved accuracy and speed of measurement is needed.

The present invention provides a different quality or type of information as compared to the prior art by using rotor dynamics to determine characteristics of the moving charge within the tumbling mill. Such a rotor dynamic information may be used independently or in addition to other types of sensor information, such as vibration or sound sensors mounted on the shell or near the shell of the grinding mill.

A monitoring apparatus is provided for monitoring a tumble mill. The apparatus includes vibration sensors mounted on the two main bearings of the tumble mill and on a thrust bearing of the mail producing vibration signals corresponding to the bearings on which the sensors are mounted. These vibration signals are transmitted to an analyzer that analyzes the signals and displays an operating condition of the tumble mill either numerically or graphically. In one embodiment the analyzer displays graphical representations of the vibration signals when the tumble mill is operating under a standard condition and also displays graphical representations of the vibration signals when the tumble mill is operating under nonstandard conditions. One primary difference between standard conditions and nonstandard conditions is the state of the charge in the tumble mill. Thus, the operator may determine changes in the charge by observing changes in the graphical representations of the vibration signals between standard and nonstandard operating conditions.

In one embodiment a pair of first sensors are mounted on the first main bearing for sensing vibration in a two different directions, where the two different directions are both radial to the axis of the first main bearing. A pair of second sensors are mounted on the second main bearing for sensing vibration in two different directions, where the directions are both radial to the axis of the second main bearing. The directional orientation of the first pair of sensors is not necessarily the same as the directional orientation of the second pair sensors. A thrust sensor is mounted on a thrust bearing in an orientation to sense vibration in a direction parallel to the rotational axis of the shell. All of the sensors produce electronic signals that are transmitted to a signal analyzer which analyzes the sensor signals to determine and display an operating condition of the mill.

The number of sensors on the main bearings may vary. For example, in one embodiment eight sensors may be mounted on both main bearings with the sensors separated by 45° around the bearings. In addition, additional sensors may be provided on or near the shell and sensors may be provided to detect the electrical input to the electrical motors driving the mill and the mechanical output produced by the electrical motors driving the mill.

In accordance with the method of the present invention, vibrations are sensed on a first main bearing of a mill and produce a first electronic signal corresponding to the sensed vibration in the first main bearing. Similarly, vibrations are sensed on the second main bearing and the thrust bearing, and second and third electronic signals are produced corresponding to the sensed vibrations on the second main bearing and the thrust bearing, respectively. The first, second and third electronic signals are analyzed to determine and display an operating condition of the tumble mill. In one embodiment shaft centerline plots are displayed corresponding to the first, second and third electronic signals.

The analyzing step may include loading the tumble mill with a standard charge and rotating the tumble mill at a standard rotational rate. The vibrations of produced by the bearings are sensed at a first time and the first, second and third electronic signals are produced while the mill is operating with the standard charge at the standard rotational rate to produce standard data. At a later time, the mill is operating under nonstandard conditions. In particular, the charge within the shell is nonstandard. The first, second and third electronic signals are produced while the mill is operating under such nonstandard condition, and nonstandard data is produced. The nonstandard data is analyzed and compared to the standard data to determine a change in the charge.

In one embodiment, the standard data and the nonstandard data are both displayed in a graphical form, for comparison by the operator. The data may also be displayed in numerical representations for comparison. In other embodiments, the data may be compared electronically, such as by subtracting corresponding standard data from corresponding nonstandard data to produce a graphical or numerical display of the comparison. The graphical display may represent this comparison. For example, the standard data and the nonstandard data may be transformed to the frequency domain and the subtraction of the data may likewise be performed in the frequency domain. Thus, the comparison data may be represented in the frequency domain.

The operating conditions of the motors may be likewise monitored. For example, the electrical input to the motors may be monitored during both standard and nonstandard operating conditions. Likewise, the mechanical outputs of the motors may be monitored during both standard and nonstandard operating conditions. The power and speed of the motors may be analyzed to determine the weight of a nonstandard charge based upon the power and speed of the motors when operating with a standard charge at a standard operating speed.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a schematic view of a tumbling mill showing five bearing sensors for monitoring vibration at the bearings and vibration monitors mounted on the shell of a tumbling mill;

FIG. 2 is an illustration of an imaginary centerline shaft of the tumbling mill graphically representing the vibration and movement of the tumbling mill;

FIGS. 3-5 are different forms of orbit graphs again representing the motion and vibration of the tumbling mill during its operation;

FIG. 6 is a somewhat diagrammatic top view of a tumbling SAG mill illustrating sensors monitoring the electrical power to the motors and torque output by the motors;

FIG. 7 is a somewhat diagrammatic view of the torque limiter and gear coupling between the motor shaft and the pinion shaft of the tumbling mill.

### DETAILED DESCRIPTION

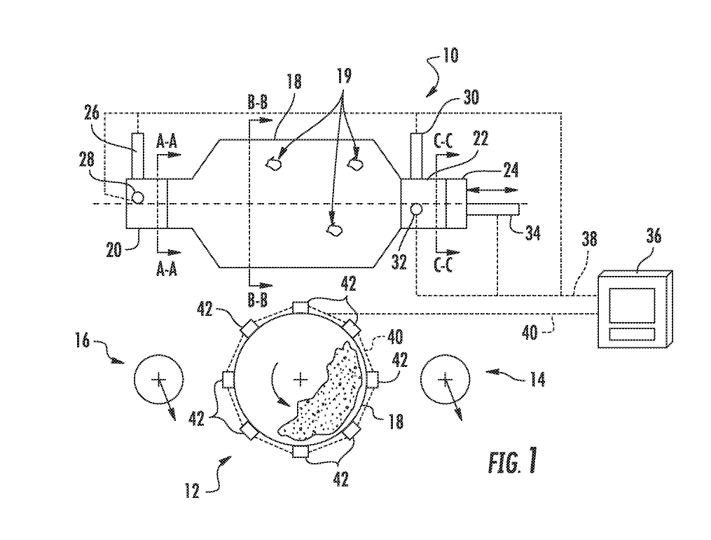

Referring to FIG. 1, a somewhat diagrammatic and schematic side view of a tumbling mill 10 is shown. Three sectional views are also shown in FIG. 1, section A-A, B-B and C-C. Section view A-A is also is also identified by the reference 16. Likewise, section B-B as identified by the reference 12 and section C-C is identified by the reference 14. The tumbling mill 10 includes a shell 18 that contains a charge of material to be tumbled and ground. For example, a rock mineral may be supplied to the shell 18 as a charge. The rock 19 and the charge will tumble against itself and the side of the shell 18 grinding itself into finer material. In a SAG mill, a supplemental material may be added to the charge to aid in the grinding process, such as steel balls.

The shell 10 is supported on two main bearings 20 and 22 and in addition a thrust bearing 24 is provided to resist thrust forces that may be generated by the shell 18 as it rotates. Vibration sensors 26 and 28 are provided on the main bearing 20 and are oriented in a direction perpendicular to the axis of rotation of the shell 18 and also perpendicular to the axis of rotation of the main bearing 20. Thus, the sensors 26 and 28 are oriented to sense vibration from the main bearing 20 along a radial direction. In this view, sensor 26 is oriented in a direction perpendicular to sensor 28. Sensors 26 and 28 may represent any number of sensors that are disposed on the main bearing 20 oriented in a radial direction. In one embodiment, eight such sensors are disposed on the main bearing 20 at 45° angles from one another around the bearing 20.

The sensors 30 and 32 are mounted and positioned on the bearing 22 in a manner similar to that of sensors 26 and 28 with respect to the main bearing 20. Thus, sensors 30 and 32 are oriented in a position to sense vibration in a radial direction with respect to the bearing 22 and are positioned 90° apart. Again, the sensors 30 and 32 may represent any number of radially disposed sensors on the bearing 22 and, again, one embodiment provides such sensors mounted 45° apart completely around the bearing 22. Thus eight different radial measurements are provided.

Sensor 34 is mounted on the thrust bearing 24 in a direction parallel to the axis of rotation of the shell 18 and thus senses thrust forces generated by the mill and resisted by the thrust bearing 24. Referring to section B-B, eight sensors 42 are illustrated on the exterior of the shell 18. These sensors are spaced apart equally around the shell and thus are disposed at 45° angles one with respect to the other.

All of the sensors discussed above are connected to a vibration analyzer 36. In this embodiment the analyzer 36 is a CSI 6500 monitoring system. The connections between the sensors and the analyzer 36 are represented by lines 38 and 40. These connections may be either wired connections or wireless connections.

Referring to the sections A-A (labeled 16) and section C-C (labeled 14) arrows are shown extending outwardly from the section views. These arrows represent force vectors that are applied to the bearings as a result of the weight and the movement of the grinding mill. These force vectors may be monitored along with vibration or sound to inform the operator about the mill process, namely, the condition of the charge.

The data from the sensors on the bearings may be analyzed and displayed using the analyzer 36 and the techniques described in U.S. Pat. 8,648,860 by Vrba et al and U.S. Pat. No. 9,063,030 to Slemp, both of which are incorporated by reference as if fully set forth herein.

The force vectors on the bearings 20 and 22 may be calculated in several ways. For example, one way is to use the angle and eccentricity of the shaft centerline compared with the bearing centerline at each bearing. For example the radial distance from the bearing center to the eccentric shaft center in a bearing is an amplitude corresponding to an amount of force being resisted by the pressurized fluid in a journal bearing. The polar angle out of gravitational plum is an angular direction for the force vector at that journal bearing. So the length and angle define a force vector of the rotor plus charge carried by that bearing location. The same can be done at the other bearing location. One or both of these force vectors may be used to interpret the forces of the rotor itself and the massive charge of materials inside the rotor at one end or both ends of the sag. Note that it is reasonable to use accelerometer information from roller bearing locations at each end of a roller bearing supported tumbling mill. The difference between using eddy current or other displacement probes and using accelerometers is well known to those skilled in the art and each approach has applicability.

A second way is to use the axial thrust force vector to monitor the axial response of the thrust bearing on the fully loaded operating mill rotor. This bearing displacement has essentially only one angular possibility due to geometric constraints; and that is co-axial with the bearing centerline. Like the journal bearing the force amplitude is related to fluid film thickness and fluid pressure in the thrust bearing. If, instead of thrust pad fluid film bearing, the mill uses another thrust bearing such as a tapered roller bearing, then it typically makes better sense to employ accelerometer measurement to measure and compute a force vector for the axial thrust response of the rotor withe materials moving from one end of the rotor to the other end.

Third is to use the vibration measured on two sides of the mill via the bull gear to drive gear. This is typically done using accelerometers as is common for gears and roller bearings which are common for this setup.

In all three of the above examples one commonly produces a synthesized response comparing two or more simultaneous or time separated measurements. For the bearings one compares to radial responses to find a resultant amplitude and angle for the force vector. For the thrust bearing one compares the displacement at first and second points in time to determine a force vector. Note that one may assume constant fluid pressure for the fluid film bearings or one may use information about changes in fluid pressure. Those skilled in the art also understand the contribution of rotor speed to fluid pressure supporting the shaft.

Fourth is to use a combination. Any one of the first three examples may be used to monitor a changing characteristic of a material or combination of composite materials within a tumbling mill. They may be used separately or all together. They may also be used with other information such as speed of mill, bearing pressure, and other inputs.

Control of a tumbling mill operation may use of empirically derived information from force-feedback-response systems of this invention. The amplitude and the direction of each force vector will change with each changing condition of the mill.

The mill operator (human or machine) uses protocol to bring that mill into acceptable operating range. Force vectors or ratios of comparison between opposing or offset sensors may be used to detect the changes caused by process condition changes.

The mill controller may adjust many factors to vary quality, volume, size, of the milling process, such as mill rotation speed, number of balls, size of balls, input material variability or consistency or size or composition, water or other fluid, This inventive technique is intended to provide the mill operator a feedback response with upper and lower control limits to allow a feedback control loop or manual control process to keep a mill in a desired range of operation.

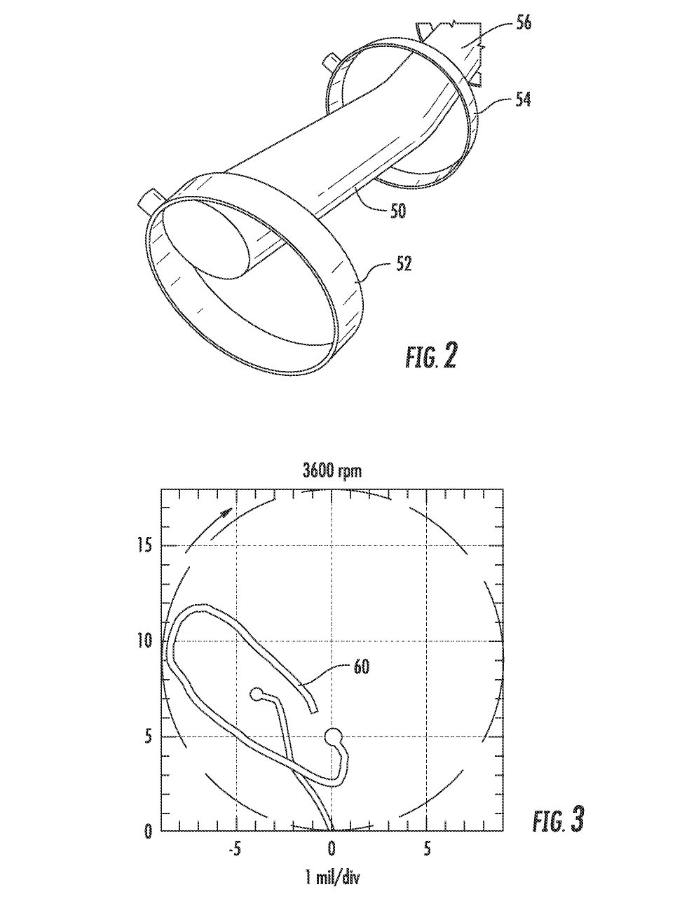

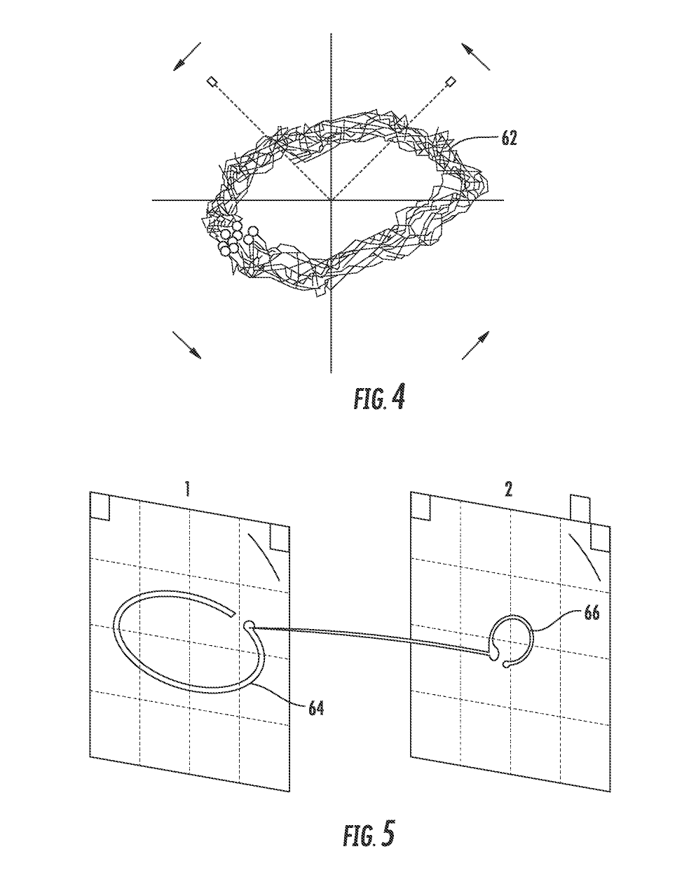

FIGS. 2-5 represent various displays that may be generated by the CSI 6500 monitoring system, the analyzer 36. The plot shown in FIG. 2 is a shaft centerline plot representing an imaginary shaft extending through the center of the tumbling mill. In FIG. 2, the rings 52 and 54 represent bearing journals or bearing housings and the shafts 50 and 56 represent shaft outer diameters. In FIG. 3, an orbit plot is shown. A practice from the art often used with this characterization of vibration is often called full spectrum analysis and is useful for translating orbit graph information into quantified orbit parameters. These quantified orbit parameters are physically meaningful for capturing causal rotor dynamic rotor movements. The graph 60 represents an orbit plot and illustrates to an operator that the shaft is orbiting in an eccentric pattern which is directly related to the combined contributions of rotor and the mass inside the rotor. In FIG. 4, another view of an orbit plot is provided and it would illustrate to the operator that multiple orbits follow a systematically repeating or a temporarily varying or an out-of-control changing pattern. The rates of change herein vary under changing position, mass, size distribution, and composition of the composite material being processed in the mill. The composite material typically comprises particulates undergoing milling processes in ranges of distributed sizes, balls in various conditions, and water.

In FIG. 5, two orbit plots 64 and 66 are shown. Plot 64 was generated time 1 and plot 66 was generated at time 2. By observing the change in the orbit plot from time 1 to time 2, the operator of the mill will observe that the magnitude of vibrations has decreased dramatically and that orbit parameters or frequencies or phases or precessions or other characteristic changes in orbit plots has likewise decreased dramatically. This information will tell the operator that something very significant has changed regarding overall operation of the mill rotor and the composite material charge being processed. Given the fact that the rotor itself is relatively consistent from moment to moment, it is reasonable to attribute a majority of decreases and increases in vibration characteristics in this application are probably traceable to changes in physical characteristics of the materials being processed inside the mill.

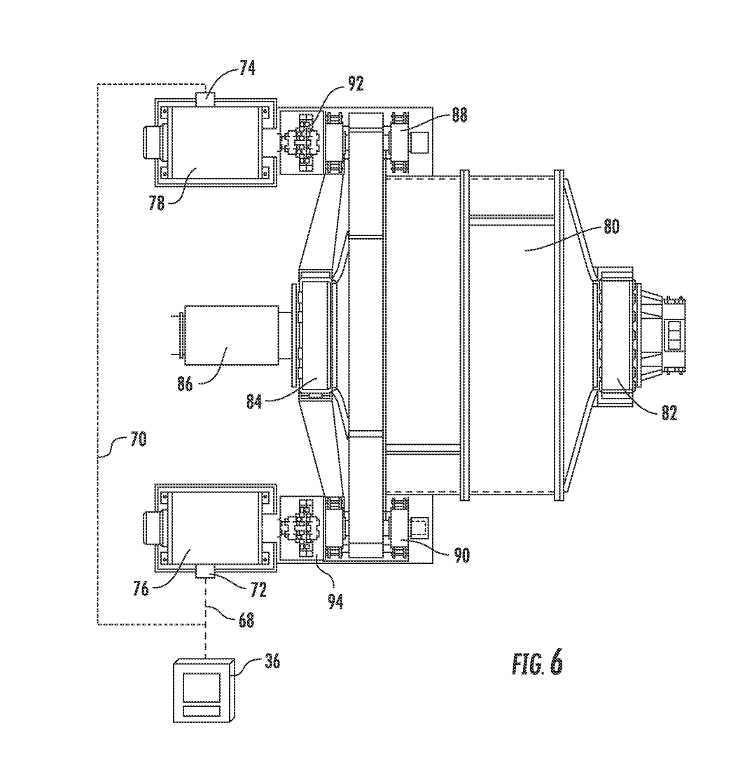

In FIG. 6 a top view of a SAG mill is shown with an analyzer 36 connected by lines 68 and 72 sensors 72 and 74 on drive motors 76 and 78, respectively. The drive motors 76 and 78 rotate the tumbler shell 78 by applying rotational drive through breaks 72 and 74 and main gear and opinions 88 and 90. The shell and he is mounted on a forward bearing 82 and a rear bearing 84. In addition, a thrust bearing 86 is provided. In this embodiment the sensors on the bearings 82, 84 and 86 and on the mill 80 are not shown, but it will be understood that these sensors would normally be present. The sensors 72 and 74 include current sensors to measure the current supplied to the motor. Based on this measurement, the electrical power to the motor can be determined. In addition, the sensors 72 and 74 include strain gauges that measure the torque at the output of the motors 72 and 74. In addition, sensors 72 and 74 include speed sensors that measure the rotational velocity of the motor outputs. By measuring the output torque and rotational velocity a more direct measurement of motor power output may be determined by the analyzer 36. The power that is produced by the motors 76 and 78 is be a good indirect measurement of the weight of the charge within the shell 80. A greater charge within the shell 80 will require a greater power output by the motors 74 and 76 to achieve the same speed as with a lesser charge. In other words, the power output of the motors 76 and 78 is directly proportional to the weight of the charge within the shell 80. This information may be used by the operator to confirm other measurements as to the weight of the charge within the shell 80, and the operating condition of the mill may be adjusted based on such information. For example, the operator may choose to increase the feed rate in order to increase the weight of the charge within the mill.

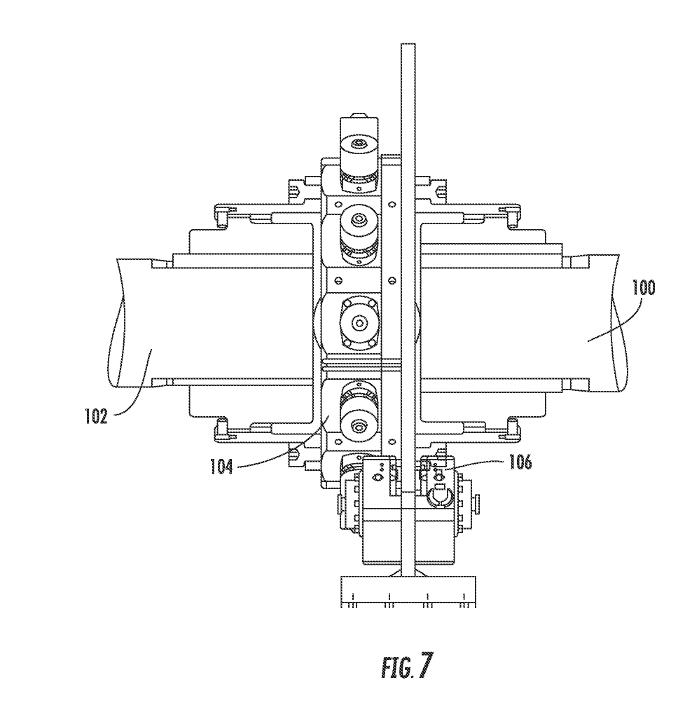

As illustrated in FIG. 7, the motors apply an output power to a motor shaft 102 that is transferred to a pinion shaft that ultimately drives the tumbling mill. A torque limiter 104 and a gear coupling 106 is positioned between the motor shaft 102 and the pinion shaft 100 for transferring forces therebetween. The analyzer 36 is programmed with the characteristics of both the torque limiter 104 and the gear coupling 106 so as to better interpret the sensor readings. Vibration readings that might be attributable to the gear coupling 106 or the torque limiter 104 may be computationally filtered out of the data so as to not interpret such vibrations as being indicative of activity in or characteristics of the charge.

### Operation and Method

In operation, a standard charge is introduced into the shell 18 (FIG. 1) and it is rotated at a standard speed. Then, the various sensors are monitored and data is obtained. This data represents a baseline measurement that represents a known charge operating under known conditions. Thus, this data represents a standard. The analyzer 36 analyzes and displays the data to the operator in graphical formats that immediately convey to the operator rotational characteristics of the shell 18 and the charge within the shell. For example, the formats shown in FIGS. 2, 3 and 4 may be calculated and displayed. Force vectors on the main bearings 20 and 22 may be calculated and displayed graphically as shown in FIG. 1 at reference characters 14 and 16. The force vectors may be calculated based in part on the power supplied to the motors, on the power detected at the output of the motors, and on the vibration detected at the two bearings 20 and 22 and the thrust bearing 24. The length of the arrow represents the magnitude of the force and the direction and position of the arrow represent the direction and position of the force on the bearing. The operator may select one or more of these graphical displays and either store them for rapid retrieval or continuously display the graphics and one portion of the analyzer screen.

As the mill continues to operate, it continuously updates the data and updates the graphical displays. At a later time, the charge will have changed due to the effect of grinding and because material is being extracted from the shell and introduced into the shell continuously. Thus, at a later time the operator may observe that the graphical displays have changed which indicates that a nonstandard charge is currently in the mill and the shell may be rotated at a nonstandard rotational rate. The operator may observe changes in the charge and the operating speed by observing the changes in the graphical displays corresponding to vibration at the bearings, electrical power input into the motors, mechanical power output of the motors, and vibration of the shell as detected by the shell sensors.

By measuring, reporting, and analyzing dynamic radial displacement, velocity, and/or acceleration movements of the rotor shaft at each bearing one may theoretically and empirically measure the movements of the charge around and through the mill. Axial displacement, velocity, or acceleration measurement further supports the empirical characterization of mass movement within the mill rotor. In addition by graphically displaying this information using intuitively understood formats, an operator will intuitively understand and correlate the graphs to the condition of the charge and the processes currently existing in the charge. As examples, the chart below provides process characteristics that may be determined by viewing the graphical information and the chart provides the corresponding physical response or effects, the sensor response, and the lag time.

Mill

| Process | Physical | Sensor | Lag |
|---|---|---|---|
| Characteristics | Response/Effects | Response | Time |
| Mill Low | Low bearing pressure and | Vibration | This is an |
| Loading | Power Draw. Mill sound | readings | operating |
| | at the plant-floor will be | increase | state. Sensor |
| | more “noisy” due to | above | response |
| | increased ball-liner | “baseline” | should track |
| | collision | levels | operating |
| | | | conditions |
| Mill | Bearing Pressure and | Vibration | This is an |
| at Desired | Power Draw at acceptable | readings | operating |
| Load | levels. Less sound due to | steady at | state. Sensor |
| | reduced ball-liner | “baseline” | response |
| | collision. | level | should track |
| | | | operating |
| | | | conditions |
| Mill at High | High bearing pressure and | Reduced | This is an |
| Load | power draw. Mill will be | vibration, | operating |
| | relatively “quiet” due to | lower than | state. Sensor |
| | lots of material padding | “baseline” | response |
| | the liners | levels | should track |
| | | | operating |
| | | | conditions |
| Increase | Increase in Bearing | Reduced | 1 minute |
| in Pulp | pressure and Power | vibration | |
| Density | Draw. Decrease in sound | | |
| | due to “cushioning” of | | |
| | media-liner impact | | |
| Decrease in | Decrease in Bearing | Increased | 1 minute |
| Pulp Density | Pressure and Power | vibration | |
| | Draw. Increase in sound | | |
| | due to loss of | | |
| | “cushioning” of media- | | |
| | liner impact | | |
| Mill Speed | Increase in power draw. | Increased | Instant |
| Increase | Gradual | vibration | |
| | stabilization/decrease in | | |
| | bearing pressure as the | | |
| | mill stabilizes/unloads. | | |
| | Increase in sound. | | |
| Mill Speed | Decrease in power draw. | Decreased | Instant |
| Decrease | Gradual | Vibration | |
| | stabilization/increase of | | |
| | bearing pressure as mill | | |
| | stabilizes/loads. Decrease | | |
| | in sound. | | |
| Increased | Increase in bearing | Decreased | <1 minute |
| Feed Rate | pressure and power draw. | Vibration | |
| | Decrease in sound. | | |
| Decreased | Decrease in bearing | Increased | <1 minute |
| Feed Rate | pressure and power draw. | Vibration | |
| | Increase in sound. | | |

As used in the chart, “baseline” is referring to the data obtained by operating the mill with a standard charge at a standard rotational velocity.

Human observable characteristics from graphical displays may also be machine interpreted. Orbit parameters, phase, frequency, precession are examples of many automated measurements suitable for use in control systems wherein upper and lower control limits are used to alert need for process adjustment when a process starts to get out of control. Common statistical methods such as statistical process control or probability density function may be applied to orbit parameters, for example, to automatically trigger a need for a correction to a process input when a mill begins to operate near a lower control limit (LCL) or upper control limit (UCL) boundary.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A monitoring apparatus for a tumble mill, the tumble mill having at least first and second main support bearings and at least a thrust bearing with a rotating shell supported on the main support bearings and the thrust bearing, the tumble mill further having at least one drive motor for rotating the shell about a rotational axis and tumbling a charge within the shell, the monitoring apparatus comprising:
a pair of first sensors mounted on the first main bearing for sensing vibration, each of the first sensors being mounted to sense vibration in a direction radial to the axis of the first main bearing, each of the first sensors being mounted to sense vibration in different radial directions relative to the first main bearing; the pair of first sensors producing first and second electronic signals corresponding to the vibration sensed by the pair of first sensors;
a pair of second sensors mounted on the second main bearing for sensing vibration, each of the second sensors being mounted to sense vibration in a direction radial to the axis of the second main bearing, each of the second sensors being mounted to sense vibration in different radial directions relative to the first main bearing; the pair of second sensors producing third and fourth electronic signals corresponding to the vibration sensed by the pair of second sensors;
at least one thrust sensor mounted on the thrust bearing for sensing vibration in a direction parallel to the rotational axis of the shell, the thrust sensor producing a fifth electronic signals corresponding to the vibration sensed by the thrust sensor;
a signal analyzer configured for receiving and analyzing the first, second, third, fourth and fifth electronic signals to determine and display condition of the charge inside the tumble mill.

2. The monitoring apparatus of claim 1 wherein the signal analyzer includes a display and is configured to display a shaft centerline plot corresponding to the rotational axis of the tumble mill.

3. The monitoring apparatus of claim 1 wherein the signal analyzer includes a display and is configured to display a shaft centerline plot corresponding to at least one of the first, second, third, fourth and fifth electronic signals.

4. The monitoring apparatus of claim 1 wherein the signal analyzer includes a display and is configured to display a shaft centerline plot based on all of the first, second, third, fourth and fifth electronic signals.

5. The monitoring apparatus of claim 1 wherein the signal analyzer includes a display and the analyzer is configured to display at least one orbit plot corresponding to at least one of the first, second, third, fourth and fifth electronic signals.

6. The monitoring apparatus of claim 1 wherein the signal analyzer includes a display and the analyzer is configured to display at least one orbit plot based on all of the first, second, third, fourth and fifth electronic signals.

7. A method for monitoring and analyzing a processing state of a tumble mill, the tumble mill having at least first and second main support bearings and at least a thrust bearing with a rotating shell supported on the main support bearings and the thrust bearing, the tumble mill further having at least one drive motor for rotating the shell about a rotational axis and tumbling a charge within the shell, the monitoring method comprising:
sensing vibration of the first main bearing and producing a first electronic signal corresponding to the sensed vibration in the first main bearing;
sensing vibration of the second main bearing and producing a second electronic signal corresponding to the sensed vibration in the second main bearing;
sensing vibration of the thrust bearing and producing a third electronic signal corresponding to the sensed vibration in the thrust bearing;
analyzing the first, second and third electronic signals to determine and display a processing condition of the tumble mill,

8. The method of claim 7 wherein said analyzing step comprises analyzing the first, second and third electronic signals to determine a shaft centerline plot corresponding to the first, second and third electronic signals and displaying the shaft centerline plot.

9. The method of claim 7 wherein said analyzing step comprises analyzing the first, second and third electronic signals to determine an orbit plot corresponding to the first, second and third electronic signals and displaying the orbit plot.

10. The method of claim 7 wherein the analyzing step comprises:
loading the tumble mill with a standard charge and rotating the tumble mill at a standard rotational rate;
sensing vibration at a first time and producing the first, second and third electronic signals while the tumble mill is operating with a standard charge at a standard rotational rate;
analyzing the first, second and third electronic signals produced at the first time to determine and display a standard vibration plot corresponding to operation of the tumble mill with a standard charge at a standard rotational rate;
operating the tumble mill with a nonstandard charge at a second time and producing the first, second and third electronic signals while operating the tumble mill with a nonstandard charge at the second time;
analyzing the first, second and third electronic signals produced at the second time to determine and display a nonstandard vibration plot corresponding to operation of the tumble mill with a nonstandard charge; and
comparing the nonstandard vibration plot with the standard vibration plot to determine a processing condition of the mill at the second time when operating with a nonstandard charge.

11. The method of claim 10 wherein the analyzing steps further comprise:
determining the difference between the standard vibration plot and the nonstandard vibration plot to produce and display a difference vibration plot corresponding to the change in a processing condition of the tumble mill between the first time and the second time.

12. The method of claim seven further comprising:
measuring the load on the motor driving the tumble mill; and
analyzing the load on the motor to determine an operational characteristic of the tumble mill.

13. The method of claim 7 further comprising:
measuring the load on the motor at a first time while driving the tumble mill with a standard charge at a standard rotational rate to determine a standard motor load;
measuring the load on the motor at a second time while driving the tumble mill with a nonstandard charge to determine a nonstandard motor load;
comparing the nonstandard motor load with the standard motor load to determine an operating characteristic of the tumble mill.

14. The method of claim 13 wherein the comparing step comprises determining a load difference between the nonstandard motor load and the standard motor load and determining a weight difference between the standard charge and the nonstandard charge based upon the load difference.

15. The method of claim 13 wherein the comparing step determines a load difference between the nonstandard motor load and the standard motor load and determines the weight of the nonstandard charge based on the load difference.

16. A monitoring apparatus for a tumble mill, the tumble mill having at least first and second main support bearings with a rotating shell supported on the main support bearings, the tumble mill further having at least one drive motor for rotating the shell about a rotational axis and tumbling a charge within the shell, the monitoring apparatus comprising:
a pair of first sensors mounted on the first main bearing for sensing vibration, each of the first sensors being mounted to sense vibration in a direction radial to the axis of the first main bearing, each of the first sensors being mounted to sense vibration in different radial directions relative to the first main bearing; the pair of first sensors producing first and second electronic signals corresponding to the vibration sensed by the pair of first sensors;
a signal analyzer configured for receiving and analyzing the first and second electronic signals to determine and display a condition of material inside the tumble mill.
